(19) United States
(12) Patent Application Publication
(10) Pub. No.: US 2013/0307866 A1
(43) Pub. Date: Nov. 21, 2013

(54) COLOR PROCESSING APPARATUS AND COLOR PROCESSING METHOD

(71) Applicant: KANON KABUSHIKI KAISHA, Tokyo (JP)

(72) Inventor: Kimitaka Arai, Yokohama-shi (JP)

(73) Assignee: Kanon Kabushiki Kaisha, Tokyo (JP)

(21) Appl. No.: 13/875,212

(22) Filed: May 1, 2013

(30) Foreign Application Priority Data
May 16, 2012 (JP) 2012-112685

(51) Int. Cl. G09G 5/02

(52) U.S. Cl. CPC G09G 5/02
USPC 345/594

(57) ABSTRACT

A UI display unit provides a user interface used to input a plurality of adjustment values required to color-match display colors of a plurality of tones on a display device with corresponding target colors of a plurality of tones. An acquisition unit acquires color matching data indicating correspondence between adjusted display colors of the plurality of tones and the target colors of the plurality of tones from the plurality of adjustment values. A calculator generates correction parameters of colors displayed on the display device from the color matching data.

### BACKGROUND OF THE INVENTION

1. Field of the Invention

The present invention relates to color processing which adjusts a display color of a display device in consideration of visual characteristics of a person.

2. Description of the Related Art

Human visual sensitivities with respect to color appearance are standardized as a color matching function by Commission Internationale de l'Éclairage (CIE). General color matching uses a method of converting colors of target devices (for example, a printer and display) into numerical values using this CIE color matching function, and numerically matching the colors.

However, the human visual sensitivities have personal differences, and do not always match the CIE color matching function. The personal differences of visual sensitivities (to be referred to as visual characteristics hereinafter) seriously influence color matching.

FIG. 1A shows an example of the relationship between colorimetric values of respective outputs when white color matching is experimentally executed for a printer and display. In a graph shown in FIG. 1A, the abscissa plots a* of an L*a*b* space, and the ordinate plots b*. Plots A to E in FIG. 1A are white measurement values on the display, which are selected by five examinees as those which match white appearance, when a white measurement value on a printed matter by the printer is set as an origin.

As shown in FIG. 1A, color matching points are different depending on personal visual characteristics. For this reason, when color matching is executed in correspondence with appearance of a specific person, another viewer often disagrees with that matching result. Even when output colors of both a printer and display are numerically matched using the CIE color matching function, they are not always matched in individual appearances.

To solve such problem, a technique for executing satisfactory color management while absorbing personal differences of the visual characteristics has been proposed. According to this technique, comparison experiments between a printed matter and display using color patches are conducted. Then, based on the experimental results, a conversion matrix to display colors corresponding to respective individuals is generated, and an image is converted using the conversion matrix, thus implementing color management that absorbs the personal differences of the visual characteristics.

According to the color management based on the above technique, when colors used in the comparison experiments are evaluated as single colors, high-precision color matching results can be obtained. However, when a gradation or photo image including colors which do not undergo the comparison experiments is to be evaluated, not only the colors which do not undergo the comparison experiments but also those which undergo the comparison experiments cannot often be matched. This tendency conspicuously appears in the neighborhood of a gray line at which personal differences of visual characteristics are particularly large.

Such matching problem is caused by an acquisition failure of personal visual characteristic data that consider a color balance with colors (neighbor colors) which neighbor experimental colors since the comparison experiments are conducted for single colors. Therefore, the aforementioned technique which conducts the comparison experiments using single colors cannot solve such matching problem even when experimental colors are increased.

### SUMMARY OF THE INVENTION

In one aspect, a color processing apparatus comprising: a provider configured to provide a user interface used to input a plurality of adjustment values required to color-match display colors of a plurality of tones on a display device with corresponding target colors of a plurality of tones; an acquisition unit configured to acquire color matching data indicating correspondence between adjusted display colors of the plurality of tones and the target colors of the plurality of tones from the plurality of adjustment values; and a generator configured to generate correction parameters of colors displayed on the display device from the color matching data.

According to the aspect, high-precision color matching which maintains a color balance in consideration of visual characteristics of individual users for a plurality of tones can be implemented.

Further features of the present invention will become apparent from the following description of exemplary embodiments with reference to the attached drawings.

### BRIEF DESCRIPTION OF THE DRAWINGS

FIGS. 1A and 1B are graphs showing the relationship between colorimetric values of color matching experiments.

FIG. 2A is a block diagram showing the arrangement of an image processing apparatus to which color processing of the present invention is applied.

FIG. 2B is a block diagram showing the arrangement of a color processing apparatus according to the first embodiment.

FIG. 3 is a flowchart showing color adjustment processing executed by the color processing apparatus.

FIG. 4 shows an example of a UI.

FIG. 5 is a table showing personal color matching data examples.

FIG. 6 shows another example of a UI.

FIG. 7 is a state transition chart showing color adjustment processing.

FIG. 8 is a table showing a data structure example of color reproducibility information of a display.

FIG. 9 is a table showing a data structure example of color information of a print color section.

FIGS. 10A and 10B are graphs showing the relationship between colorimetric values of print and display colors when they are matched.

FIG. 11 is a state transition chart showing color adjustment processing according to the second embodiment.

FIG. 12 shows a UI example according to the third embodiment.

FIG. 13 is a state transition chart showing color adjustment processing according to the third embodiment.

FIG. 14 shows an example of an adjustment color definition table according to the third embodiment.

FIG. 15 is a flowchart showing display color decision processing according to the third embodiment.

FIG. 16 shows a first UI example according to the fourth embodiment.

FIG. 17 shows a second UI example according to the fourth embodiment.

FIG. 18 is a state transition chart showing color adjustment processing according to the fourth embodiment.

FIGS. 19A and 19B are graphs showing adjustment routes in color matching experiments.

FIG. 20 shows a third UI example according to the fifth embodiment.

FIG. 21 is a state transition chart showing color adjustment processing according to the fifth embodiment.

FIG. 22 is a table showing a data structure example of adjustment history information according to the fifth embodiment.

FIG. 23 shows a fourth UI example according to the sixth embodiment.

FIG. 24 is a state transition chart showing color adjustment processing according to the sixth embodiment.

### DESCRIPTION OF THE EMBODIMENTS

Embodiments according to the present invention will be described hereinafter with reference to the drawings. Note that the following embodiments do not limit the present invention associated with the scope of the claims, and all of combinations of features described in the embodiment are not always indispensable for solutions of the present invention.

### First Embodiment

[Color Matching Experiment]

As described above, color matching experiments have to be conducted to acquire personal visual characteristic data by comparison experiments of color patches on a printed matter and display so as to execute color management in consideration of personal differences of visual characteristics. However, when the color matching experiments are conducted based on single colors, since visual characteristic data that consider color balances with neighbor colors cannot be obtained, it becomes particularly difficult to attain matching in the vicinity of a gray line.

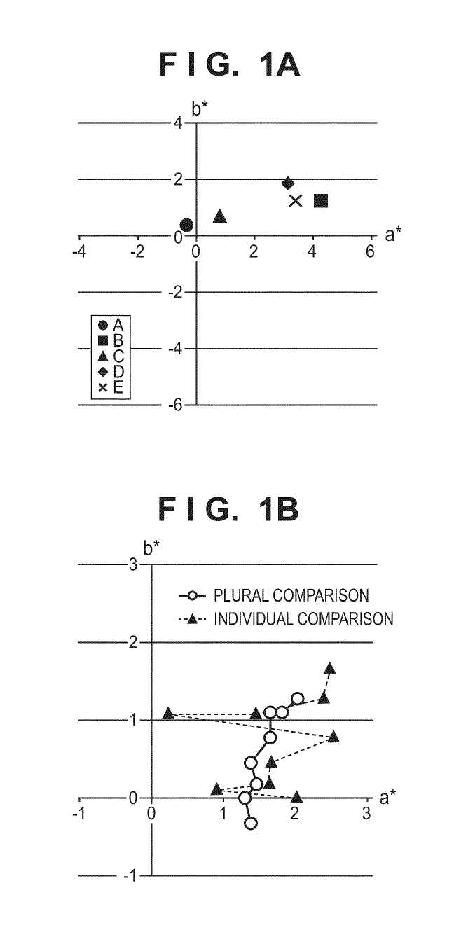

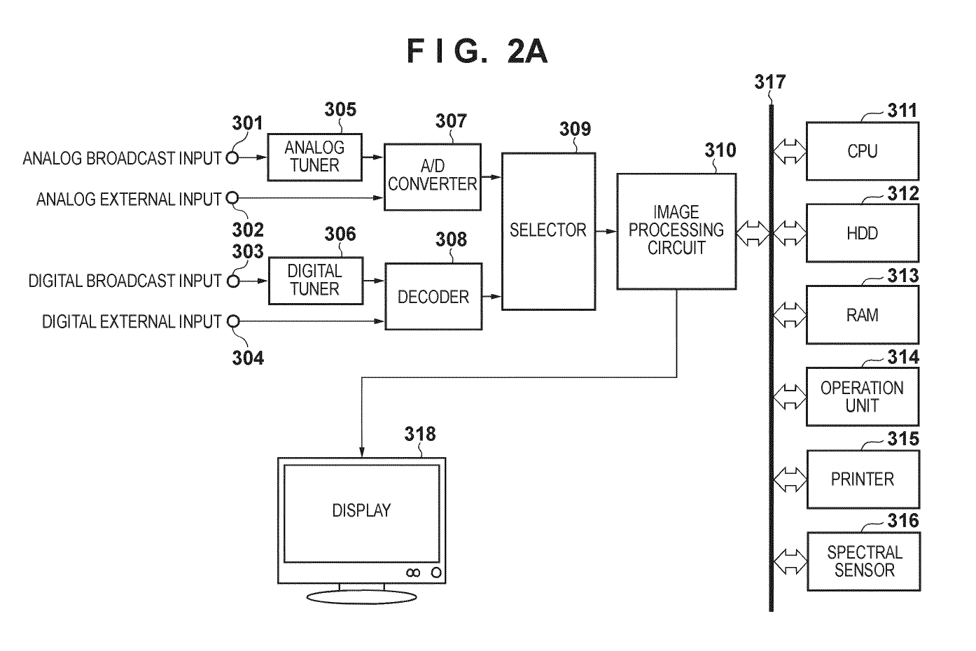

FIG. 1B shows an example of results of color matching experiments for comparing color patches on a display and those on a printed mater for each of single colors and for nine tones at the same time in association with the nine tones from white to black.

FIG. 1B shows colorimetric values as a result of color matching of display colors to print colors. In a graph of FIG. 1B, the abscissa plots a* of an L*a*b* space, and the ordinate plots b*. Symbol ⋄ represents colorimetric values obtained when a comparison for each color is made (to be referred to as “individual comparison” hereinafter), and symbol ◯ represents colorimetric values obtained when a simultaneous comparison for a plurality of neighboring tones is made (to be referred to as “plural comparison” hereinafter).

As can be seen from FIG. 1B, variations of the colorimetric values of respective tones caused by the individual comparison are reduced in the plural comparison, and a whole gray color balance is maintained.

[Image Processing Apparatus]

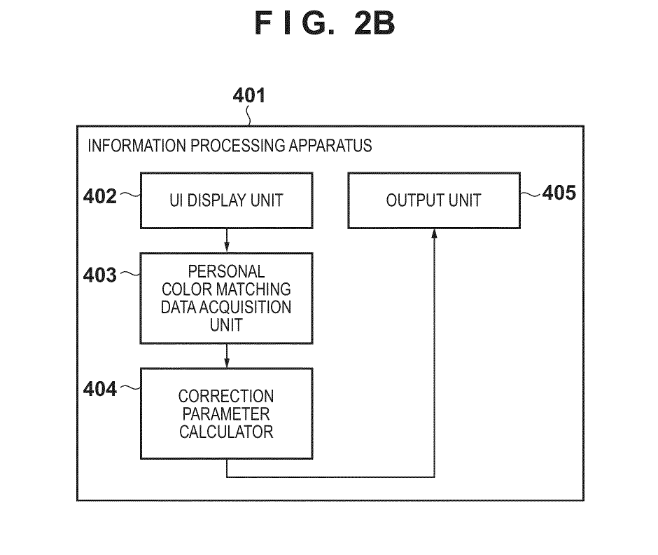

FIG. 2A is a block diagram showing the arrangement of an image processing apparatus to which color processing of the present invention is applied. An analog broadcast input terminal 301 inputs analog broadcast signals of terrestrial analog broadcasting, satellite analog broadcasting, and the like. An analog external input terminal 302 is, for example, a D terminal, and inputs analog video signals. A digital broadcast input terminal 303 inputs digital broadcast signals of terrestrial digital broadcasting, satellite digital broadcasting, and the like. A digital external input terminal 304 is, for example, an HDMI (High-Definition Multimedia Interface) terminal, and inputs digital video signals.

An analog tuner 305 converts an analog broadcast signal into an analog video signal. A digital tuner 306 converts a digital broadcast signal into a digital video signal. An analog-to-digital (A/D) converter 307 converts an analog video signal into a digital video signal. A decoder 308 decodes an encoded video signal such as an MPEG (Moving Picture Experts Group) signal. A selector 309 selects one of the A/D-converted video signal and decoded video signal, and outputs the selected video signal.

An image processing circuit 310 applies image quality enhancement image conversion such as resolution conversion and edge correction to a video signal input from the selector 309 based on given parameters.

A CPU (microprocessor) 311 controls operations of all the above units. An HDD (Hard Disk Drive) 312 and a main memory 313 such as a RAM (Random Access Memory) provide programs, data, work areas, and the like required for processing to the CPU 311.

An operation unit 314 is a device used to input a user instruction, and corresponds to a touch panel which receives inputs from a display, instruction input buttons, and the like. A printer 315 prints a video signal as a color image in accordance with an instruction from the CPU 311. A spectral sensor 316 measures an illumination environment, display color information, printer color information, and the like. A main bus 317 connects the image processing circuit 310 and the CPU 311 to spectral sensor 316. A display 318 displays a video and image based on a video signal after image processing.

Various kinds of processing to be described later are implemented when the CPU 311 executes various kinds of software (computer programs) stored in the HDD 312. That is, the CPU 311 loads a color processing application stored in the HDD 312 onto the RAM 313 in accordance with a user instruction via the operation unit 314, and executes the loaded application, thereby displaying a UI (User Interface) on the display 318.

Subsequently, various data stored in the HDD 312 are transferred to the RAM 313 via the main bus 317 based on an instruction from the CPU 311. Various data transferred to the RAM 313 undergo predetermined arithmetic processing by the CPU 311, and arithmetic processing results are displayed on the display 318 by the image processing circuit 310 or are stored in the HDD 312 via the main bus 317.

[Color Processing Apparatus]

Processing for calculating correction parameters corresponding to personal visual characteristics by the CPU 311 which executes the color processing application will be described below. FIG. 2B is a block diagram showing the arrangement of a color processing apparatus according to the first embodiment. Note that the arrangement shown in FIG. 2B is implemented when the CPU 311 executes the color processing application, as described above. The first embodiment will exemplify a color processing application for calculating color correction parameters corresponding to personal visual characteristics.

Referring to FIG. 2B, a color processing apparatus 401 includes a UI display unit 402, personal color matching data acquisition unit 403, correction parameter calculator 404, and output unit 405. The UI display unit 402 displays a UI (User Interface) and the like on the display 318. The personal color matching data acquisition unit 403 acquires an adjustment result input from the UI on the display 318 or the operation unit 314 by a user as personal color matching data of that user. The correction parameter calculator 404 calculates correction parameters according to the personal visual characteristics based on the personal color matching data. The output unit 405 stores the correction parameters calculated by the correction parameter calculator 404 in the HDD 312 as a data file.

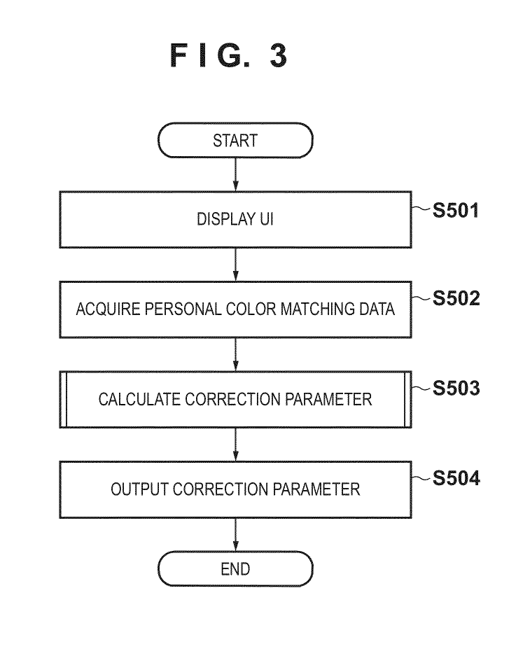

FIG. 3 is a flowchart showing processing executed by the color processing apparatus 401. The UI display unit 402 displays a UI, which prompts the user to input information required to acquire personal visual characteristics, on the display 318 (S501). The user makes color matching adjustment on this UI, as will be described in detail later.

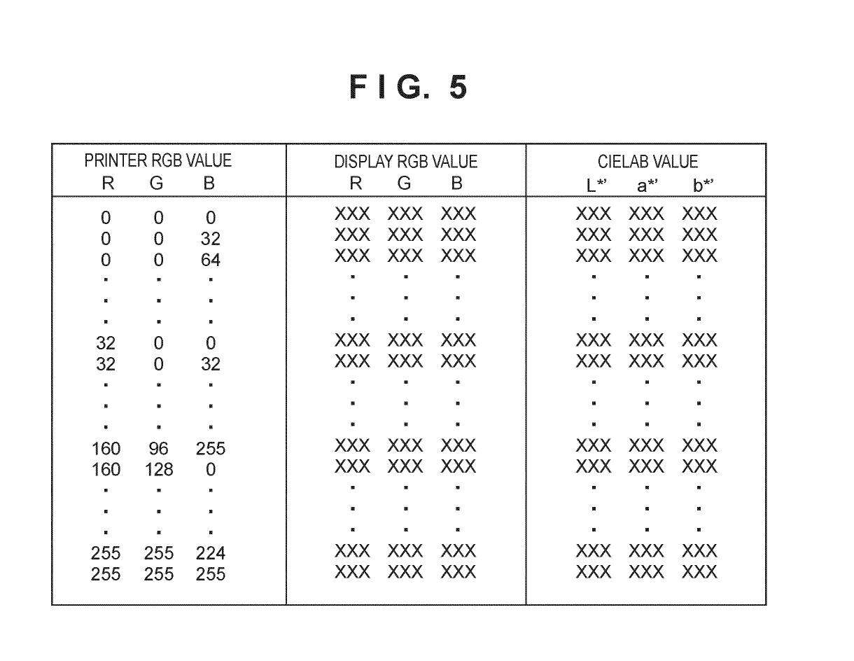

Next, the personal color matching data acquisition unit 403 acquires a color matching adjustment result input on the UI displayed in step S501 as personal color matching data of the user (S502). The personal color matching data describes device RGB values of a first device (for example, a printer) as a reference upon execution of personal color matching adjustment, those of a second device (for example, a display) as an adjustment target, and CIELab values corresponding to those device RGB values as shown as an example of FIG. 5. Note that L*′a*′b*′ values shown in FIG. 5 indicate L*a*b* values after adjustment according to the first embodiment, but personal color matching data need only hold a correspondence relationship of respective values in the adjustment.

Next, the correction parameter calculator 404 calculates correction parameters from the personal color matching data acquired in step S502 (S503). The correction parameter calculation method will be described in detail later. Then, the output unit 405 outputs the correction parameters calculated in step S503 to the HDD 312 (S504), thus ending the processing.

User Interface

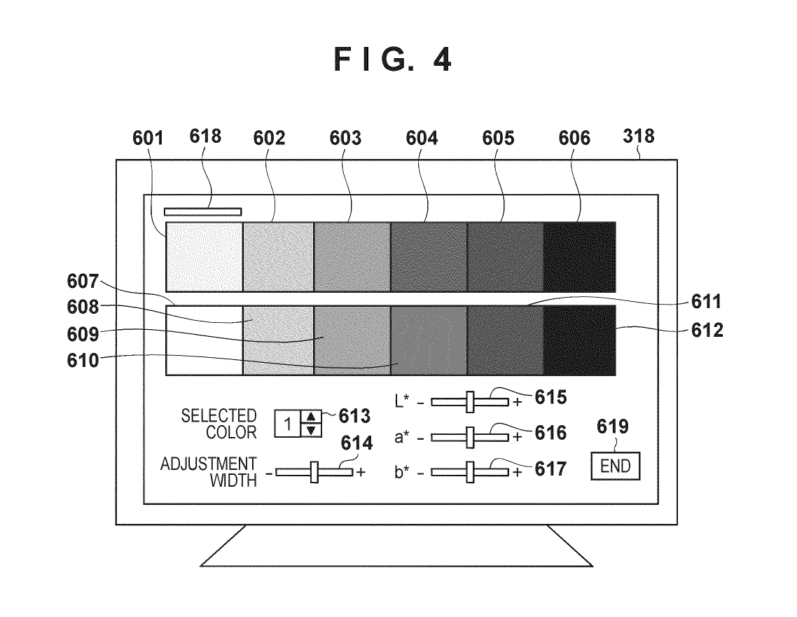

FIG. 4 shows a UI example displayed by the UI display unit 402. Referring to FIG. 4, a color display section displays colors 601 to 606 of a plurality of tones on the display 318. A print color section is displayed by laying out a printed matter obtained by printing colors 607 to 612 of a plurality of tones on a recording medium on the screen of the display 318. For example, the print color section can use a standard color chart or grayscale chart.

As the layout method of the print color section on the screen, a printed matter may be adhered, or the user may hold the printed matter. That is, the color display section having nearly the same shape and allocation as the shape of the printed matter or chart and an allocation of the print color section corresponding to the colors 607 to 612 is displayed on the screen.

A tone layout of the colors 601 to 606 of the color display section on the display surface of the display 318 corresponds to that of the colors 607 to 612 of the print color section, which is prepared in advance. That is, corresponding tones of display colors and print colors are laid out at neighboring positions to be compared with each other. Then, the user adjusts the colors 601 to 606 of the color display section to have color appearances equivalent to the corresponding colors 607 to 612 of the print color section. That is, the colors 607 to 612 of the print color section function as target colors as adjustment targets of the corresponding colors 601 to 606 of the color display section. The colors 601 to 606 of the color display section and the colors 607 to 612 of the print color section will be referred to as “color patches” hereinafter.

The user selects (the number of) an adjustment target color using spin buttons 613. A slider 614 is used to decide a display adjustment width. Sliders 615, 616, and 617 are respectively used to adjust L*, a*, and b* of the selected display color. Note that the sliders 615, 616, and 617 can be individually adjusted. A selected color marker 618 is displayed above a tone as a current adjustment target selected by the spin buttons 613 of the color patches 601 to 606 of the color display section. An end button 619 is used to instruct settlement of color matching adjustment, and when the user presses the end button 619, the current adjustment result is stored in the HDD 312, thus closing the displayed UI.

Note that the UI shown in FIG. 4 is merely an example. For example, in FIG. 4, a background color of the display surface of the display 318 is white. Although the background color is not particularly limited, a dark color such as black is preferable for the user to visually recognize the color patches.

FIG. 4 shows the example in which the color patches 601 to 606 of six tones are displayed on the color display section, and color matching adjustment to the color patches 607 to 612 of the print color section is executed. However, the number of tones may be increased/decreased as long as a plurality of tones corresponding to print colors of a plurality of tones can be displayed. Note that in order to acquire personal color matching data in consideration of a color balance, color matching adjustment is desirably executed for at least three tones. Also, in FIG. 4, a color patch shape of each tone is a square, but it is not particularly limited as long as the user can easily visually recognize each color patch. Therefore, for example, a boundary of each color patch may be a smooth curve, or a polygon, an elevation angle of each vertex of which is larger than a right angle, or a circle may be used.

FIG. 4 shows the example in which the color patches of print colors and those of display colors are vertically laid out. The positional relationship between these color patches is not particularly limited as long as corresponding color patches can be easily visually recognized. Therefore, the color patches of the print colors and those of the display colors may be laid out so that color patches of the same tone are juxtaposed. For example, these color patches may be laid out to be arranged side by side.

A tone change direction in the color patches is not particularly limited, and a direction opposite to the change direction shown in FIG. 4 (to be brighter from the left to the right) may be used, or a random tone order may be adopted as long as corresponding color patches are juxtaposed. FIG. 4 shows the example in which the plurality of color patches as continuous tones are continuously displayed as display colors at neighboring positions, but the color patches between the continuous tones may be separately displayed or the corresponding color patches of the print and display colors may be displayed at neighboring positions.

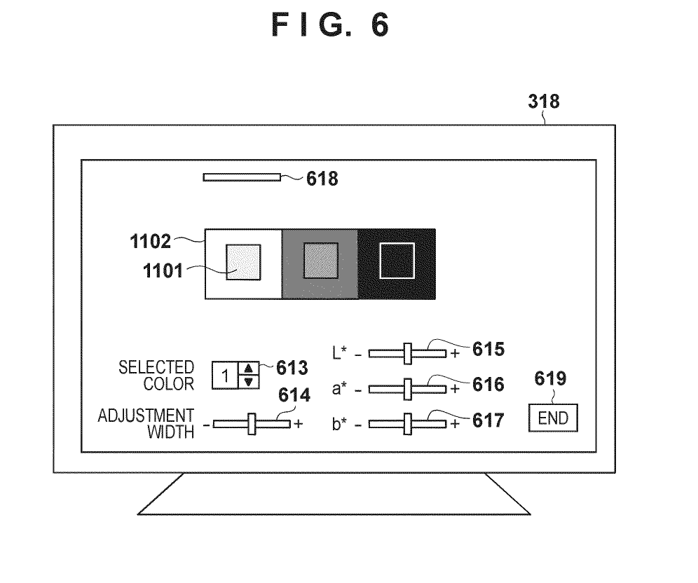

FIG. 4 shows the color patches of the print colors and display colors to have the same shape. However, the sizes and shapes of these color patches may be different. For example, a color patch 1101 of a print color may be laid out at the center of a color patch 1102 of a display color, as shown in FIG. 6. In this case, black is desirably displayed on a region of the color patch 1102 of the display color as a background of the color patch 1101 of the print color, so as to eliminate the influence of transmission light from a backlight.

Color Matching Adjustment Processing

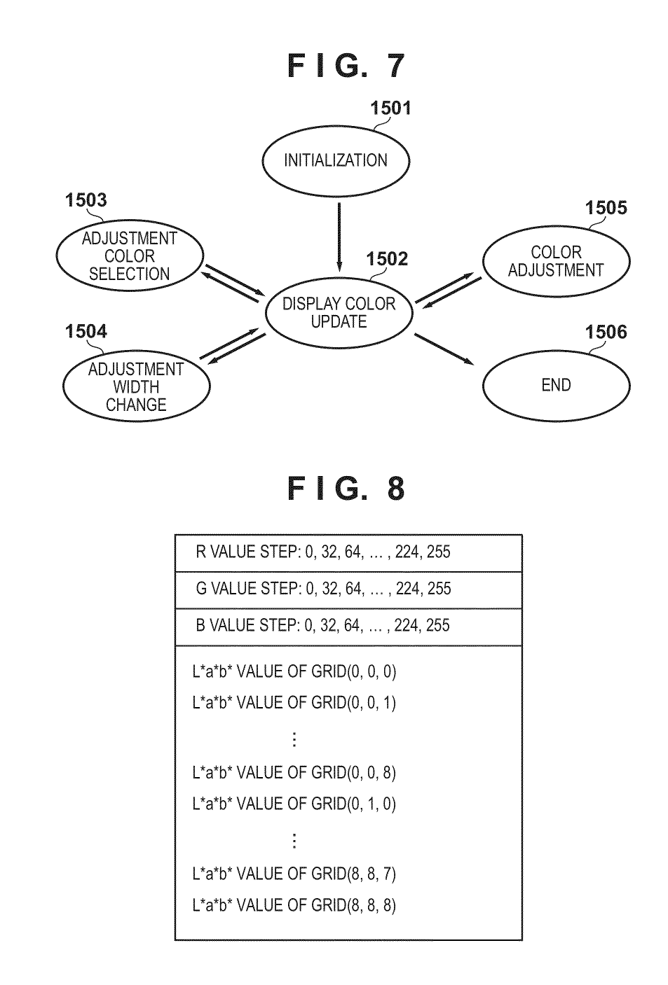

Inputs to the UI shown in FIG. 4 and color matching adjustment processing according to these inputs will be described below using the state transition chart shown in FIG. 7. In FIG. 7, a state 1501 is an initial state. In this state, color reproducibility information of the display 318 and color information of the print color section are loaded, and the initial state then transits to a display color update state 1502.

The color reproducibility information of the display is, for example, a table which describes L*a*b* data corresponding to grid points of an RGB color space, as shown in FIG. 8. More specifically, steps of R, G, and B values which form the grid points of the RGB color space are described at the beginning of the data structure, and are followed by a description of L*a*b* values corresponding to the grid points, which are nested in an order of R, G, and B.

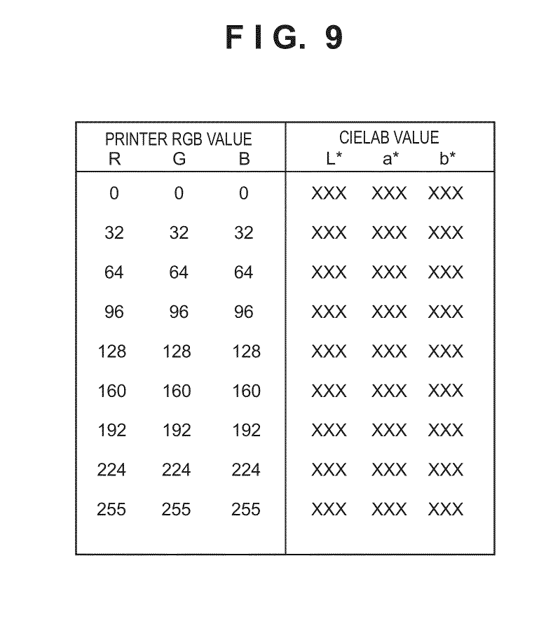

Also, the color information of the print color section describes predetermined coordinate values (grayscale values in the example of FIG. 9) on the RGB color space and corresponding L*a*b* values. Note that the color reproducibility information of the display and the color information of the print color section shown in FIGS. 8 and 9 are generated by measuring a predetermined sample using, for example, the spectral sensor 316 and the like. Especially, the color information of the print color section is obtained by measuring a printed matter which corresponds to a printed matter used as the color patches 607 to 612 of the print color section, and on which color patches of a plurality of continuous tones are formed.

The L*a*b* values for predetermined tones (in the example of FIG. 4, six gray tones) described as the color information of the print color section are stored in the RAM 313 as initial color information (L_{di}*a_{di}*b_{di}* to be described later) of each of the color patches 601 to 606 of the color display section on the display 318. At this time, RGB values corresponding to the color information of the print color section are also stored in the RAM 313. Note that tones of the plurality of colors selected from the print color information as the initial color information of the color patches 601 to 606 of the color display section are desirably continuous. In the following description, let N be the number of display colors on the display 318, i (i=0 to N−1) be an identification number of a color patch to be displayed, and L_{di}*a_{di}*b_{di}* be data stored in the RAM 313 as color information of each of the color patches 601 to 606 of the color display section. Also, let R_{di}G_{di}B_{di} be RGB values of the display 318 corresponding to L_{di}*a_{di}b_{di}* values.

In the state 1502, the color information L_{di}*a_{di}*b_{di}* stored in the RAM 313 in the state 1501 or a state 1505 to be described later is converted into R_{di}G_{di}B_{di} values by tetrahedral interpolations using the table shown in FIG. 8. After RGB values used to display the color patches 601 to 606 on the color display section are updated by the R_{di}G_{di}B_{di} values, and the control then transits to a user input waiting state.

In the input waiting state of the state 1502, when the user operates the spin button 613 used to select an adjustment target color, the state 1502 transits to an adjustment color selection state 1503. In the state 1503, “i” which represents the identification number of the selected color and the display position of the selected color marker 618 are changed according to the operation result of the spin buttons 613, and the state 1603 transits to the state 1502.

In the input waiting state of the state 1502, when the user operates the slider 614 used to set a display adjustment width, the state 1502 transits to an adjustment width change state 1504. In the state 1504, a value of a variable α (<0) which represents a display adjustment variation width is stored in the RAM 313 according to the operation result of the slider 614, and the state 1504 transits to the state 1502.

In the input waiting state of the state 1502, when the user operates any of the sliders 615, 616, and 617 used to adjust L*a*b* values of the selected color, the state 1502 transits to a color adjustment state 1505. In the state 1505, when the user operates the slider 615, L_{di}* of the selected color is changed. In this case, letting L_{di}*′ be L_{di}* after change, a change when the slider 615 is slid in a plus (+) direction is described by:

L_{di}*′=L_{di}*+α (1)

Also, a change when the slider 615 is slid in a minus (−) direction is described by:

L_{di}*′=L_{di}*+α (2)

Likewise, when the user operates the slider 616, a_{di}* of the selected color is changed. Letting a_{di}*′ be a_{di}* after change, a change when the slider 616 is slid in the plus direction is described by:

a_{di}*′=a_{di}*+α (3)

Also, a change when the slider 616 is slid in the minus direction is described by:

a_{di}*′=a_{di}*−α (4)

Likewise, when the user operates the slider 617, b_{di}* of the selected color is changed. Letting b_{di}*′ be b_{di}* after change, a change when the slider 617 is slid in the plus direction is described by:

b_{di}*′=b_{di}*+α (5)

Also, a change when the slider 617 is slid in the minus direction is described by:

b_{di}*′=b_{di}*−α (6)

In the state 1505, the user performs color adjustment using the sliders 615, 616, and 617 while comparing each of the color patches 601 to 606 of the color display section with corresponding one of the color patches 607 to 612 of the print color section, so that the display colors are color-matched with the print colors. In the state 1505, when any of the sliders 615, 616, and 617 is changed, L*a*b* values according to that change result, that is, L_{di}*′a_{di}*′b_{di}*′ values described by equations (1) to (6) are stored in the RAM 313, and the state 1505 transits to the state 1502.

In the input waiting state of the state 1502, when the user presses the end button 619 used to settle the color matching adjustment result, the state 1502 transits to an end state 1506. In the state 1506, L_{di}*′a_{di}*′b_{di}*′ values currently stored in the RAM 313 are output to the personal color matching data acquisition unit 403 as personal color matching data of the user together with the corresponding display RGB values and printer RGB values.

As shown in FIG. 5, the personal color matching data has R_{di}G_{di}B_{di} values currently displayed as the color patches 601 to 606 of the color display section of the display 318 as display RGB values corresponding to the adjusted L_{di}*′a_{di}*′b_{di}*′ values. Also, the personal color matching data has RGB values which are stored in the RAM 313 and correspond to the print color information L*a*b* set as the initial color information of the color patches 601 to 606 of the color display section in the state 1501 as print RGB values for the adjusted L_{di}*′a_{di}*′b_{di}*′ values.

Correction Parameter Calculation Processing

The correction parameter calculation processing in step S503 above will be described below. In step S503, the correction parameter calculator 404 calculates correction parameters according to the visual characteristics of an individual user based on the personal color matching data acquired by the color matching adjustment.

Letting RₚᵢGₚᵢBₚᵢ be printer RGB values in the personal color matching data, a conversion matrix required to convert the printer RGB values into display RGB values R_{di}G_{di}B_{di} is generated (equation 7). This conversion matrix is given by:

$$( \begin{matrix}{R}_{di} \\ {G}_{di} \\ {B}_{di}\end{matrix} ) = ( \begin{matrix}{a}_{1 , 1} & {a}_{1 , 2} & {a}_{1 , 3} & {a}_{1 , 4} \\ {a}_{2 , 1} & {a}_{2 , 2} & {a}_{2 , 3} & {a}_{2 , 4} \\ {a}_{3 , 1} & {a}_{3 , 2} & {a}_{3 , 3} & {a}_{3 , 4}\end{matrix} ) ( \begin{matrix}{R}_{pi} \\ {G}_{pi} \\ {B}_{pi} \\ 1\end{matrix} ) \qquad ( 7 )$$

This matrix can be calculated using, for example, a least square method or the like based on the correspondence relationship between the printer RGB values RₚᵢGₚᵢBₚᵢ and the display RGB values R_{di}G_{di}B_{di} in the personal color matching data.

Note that the 3×4 conversion matrix given by equation (7) is merely an example. For example, a 3×7 matrix using up to secondary terms may be generated. The first embodiment has exemplified the case in which the matrix is calculated as an RₚᵢGₚᵢBₚᵢ→R_{di}G_{di}B_{di} conversion formula. However, upon specializing to color adjustment of continuous grayscale tones, one-dimensional lookup table (1DLUT) or the like, which is targeted at grayscale, can be used. Equation (7) presents the conversion matrix on the RGB color space as the correction parameters. Alternatively, conversion parameters on other color spaces such as an XYZ color space and L*a*b* color space can also be calculated, as a matter of course. For example, R, G, and B in equation (7) may be respectively replaced by X, Y, and Z or L*, a*, and b*.

As described above, by conducting color matching experiments using the UI used to simultaneously compare colors of a plurality of neighboring tones, visual characteristic information of an individual user, which maintains a color balance of the colors of the plurality of tones can be acquired, and color matching with higher precision can be executed. Especially, by practicing the first embodiment to have colors of a plurality of tones in the neighborhood of a gray line where the personal differences of the visual characteristics are large, a color balance of the gray line can be maintained. Thus, high matching precision can be attained not only for single colors but also for a photo image and gradation.

### Second Embodiment

The second embodiment according to the present invention will be described below. The aforementioned first embodiment has explained the method of acquiring personal visual characteristic information in consideration of a color balance of a gray line by conducting color matching experiments by plural comparison. With the method of the first embodiment, the user carries out adjustment from predetermined initial values (print measurement values) for all tones of display colors. However, when the user repetitively carries out the adjustment while evaluating slight color differences to have arrival at corresponding points as a goal, a very heavy load is imposed on the user. The user has to carry out such heavy load operations for a plurality of tones under stressful conditions.

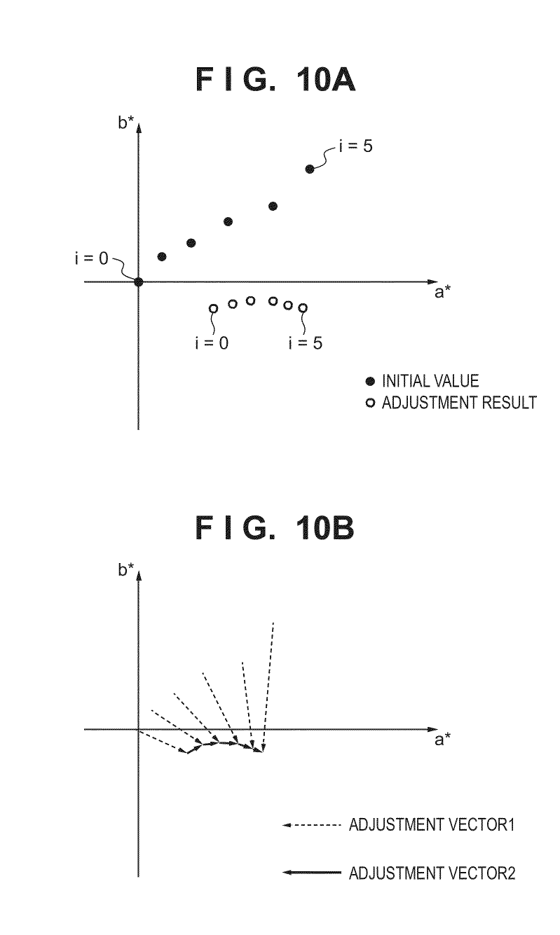

On the other hand, in comparison experiments in the neighborhood of a gray line, it is experimentally revealed that color adjustment directions are different between individuals but color adjustment directions tend to be very similar for each individual. FIG. 10A shows an example of color matching experiments between print colors and display colors in association with six gray tones by the aforementioned method of the first embodiment. In a graph of FIG. 10A, the abscissa plots a* of an L*a*b* space, and the ordinate plots b*. Also, symbol indicates pieces of print color information (print colorimetric values) of print RGB values shown in FIG. 9 for tones to be adjusted, and symbol ◯ indicates adjustment results of display colors of respective tones.

FIG. 10B shows adjustment vectors (adjustment vectors 1: broken line arrows) of respective tones when print colorimetric values are used as initial setting values, and adjustment vectors (adjustment vectors 2: solid line arrows) of respective tones when tone adjustment results of immediately preceding processing are used as initial setting values.

As can be seen from FIG. 10B, adjustment amounts of adjustment vectors 2 when the immediately preceding adjustment results are used as initial setting values are smaller than those of adjustment vectors 1 for respective tones.

Hence, the second embodiment will explain a method of reducing the operation load on the user by executing adjustment for a certain tone using adjustment results of an already adjusted tone. Note that the arrangement of a color processing apparatus according to the second embodiment is the same as that of the first embodiment, and a description will not be repeated. Color correction parameter calculation processing of the second embodiment will be briefly described below while focusing on differences from the first embodiment.

Correction Parameter Calculation Processing

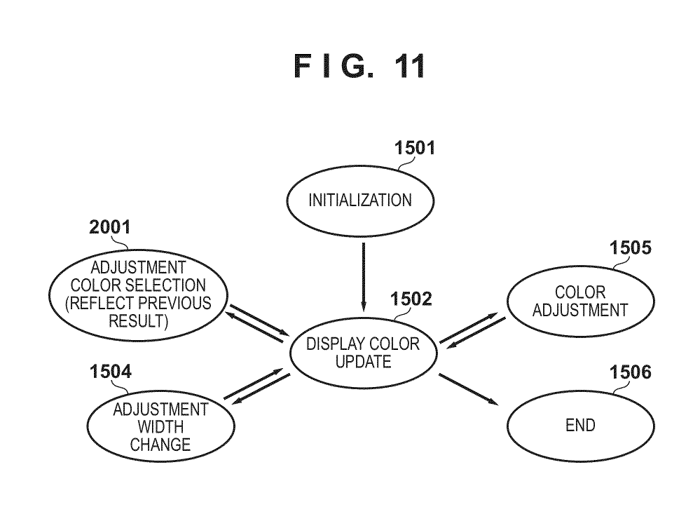

Under the assumption that a UI display unit 402 displays a UI shown in FIG. 4 in the second embodiment as well, inputs to the UI and color matching adjustment processing of the second embodiment according to the inputs will be described below with reference to a state transition chart shown in FIG. 11. Note that the same reference numerals in FIG. 11 denote the same states as in FIG. 7, and a description thereof will not be repeated.

The color matching adjustment processing shown in FIG. 11 is characterized in that the result of adjustment which has already been done for a color of a neighboring tone is reflected in an adjustment color selection state 2001. In an input waiting state of a state 1502, when the user operates spin buttons 613 used to select an adjustment target color, the state 1502 transits to the state 2001. In the state 2001, after an identification number of a selected color and a display position of a selected color marker 618 are changed according to the operation result of the spin buttons 613, the state 2001 transits to the state 1502.

In the second embodiment, upon changing a selected color, an adjustment value for a color patch of a tone which neighbors a color patch of the selected color is reflected. That is, letting i be an identification number of a color patch of the current selected color and j (=i±1) be an identification number of a color patch of an already adjustment neighboring tone, chromaticity values of the color patch i of the selected color are changed to values, as described by:

a_{di}*=a_{dj}* (8)

b_{di}*=b_{dj}* (9)

The change results (a_{di}* and b_{di}*) are stored in a RAM 313. That is, as the chromaticity values of an adjustment target color, the adjustment values of the color of the already adjusted neighboring tone are set.

In this manner, using a tendency that color adjustment directions in the neighborhood of a gray line are very similar to each other, adjustment results of a color of a certain tone are reflected to initial values of adjustment of a color of a neighboring tone. Thus, compared to adjustment from specific initial values which are not related to personal visual characteristics, the operation load on the user can be greatly reduced.

### Third Embodiment

The third embodiment according to the present invention will be described below. The aforementioned second embodiment has explained the method of reducing the operation load on the user by reflecting immediately preceding adjustment results to initial values of adjustment of the next color. However, with the method of the second embodiment, since the user carries out adjustment for all tones as adjustment targets displayed on a display 318, an operation load becomes heavier with increasing the number of tones as matching targets.

On the other hand, in general, print colors are designed so that gray tones smoothly change in terms of suppression of pseudo contours and tone jumps. It is experimentally revealed that if gray tones of print colors smoothly change, color matching points of display colors and print colors also smoothly change. For this reason, by executing interpolations from neighboring experimental results even for tones which do not undergo color matching experiments, values in the neighborhood of color matching points can be obtained although precision lowers compared to direct adjustment of colors of those tones.

Hence, the third embodiment will exemplify a case in which personal visual characteristics which attains both maintenance of a whole gray line color balance and matching are acquired by adjusting some of gray tones as matching targets. Note that the arrangement of a color processing apparatus according to the third embodiment is the same as that of the first embodiment described above, and a description thereof will not be repeated. Color correction parameter calculation processing of the third embodiment will be briefly explained below while focusing on differences from the first and second embodiments.

User Interface

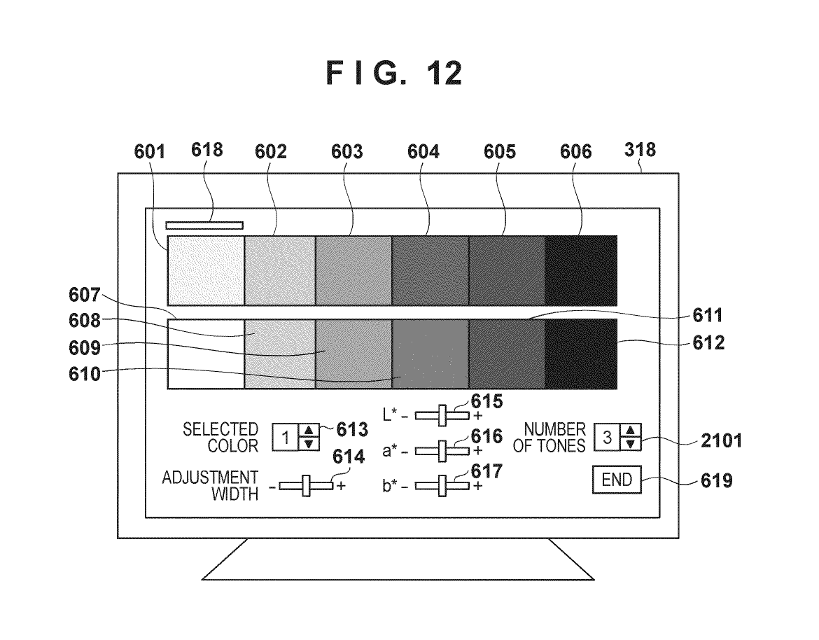

FIG. 12 is a view for explaining a user interface to be displayed by a UI display unit 402 according to the third embodiment. In FIG. 12, the same reference numerals denote the same components as those in FIG. 4 of the first embodiment described above, and a description thereof will not be repeated. In FIG. 12, spin buttons 2101 are used to select the number of tones as adjustment targets. The number M of tones selectable using the spin buttons 2101 meets 3≦M≦N (N: the number of display colors). Assuming that two out of M tones are ends of tones indicated by color patches 601 to 606 of a color display section, arbitrary tones between the two ends can be selected as remaining tones M−2. Note that an initial value for the spin button 2101 is M=N.

Color Matching Adjustment Processing

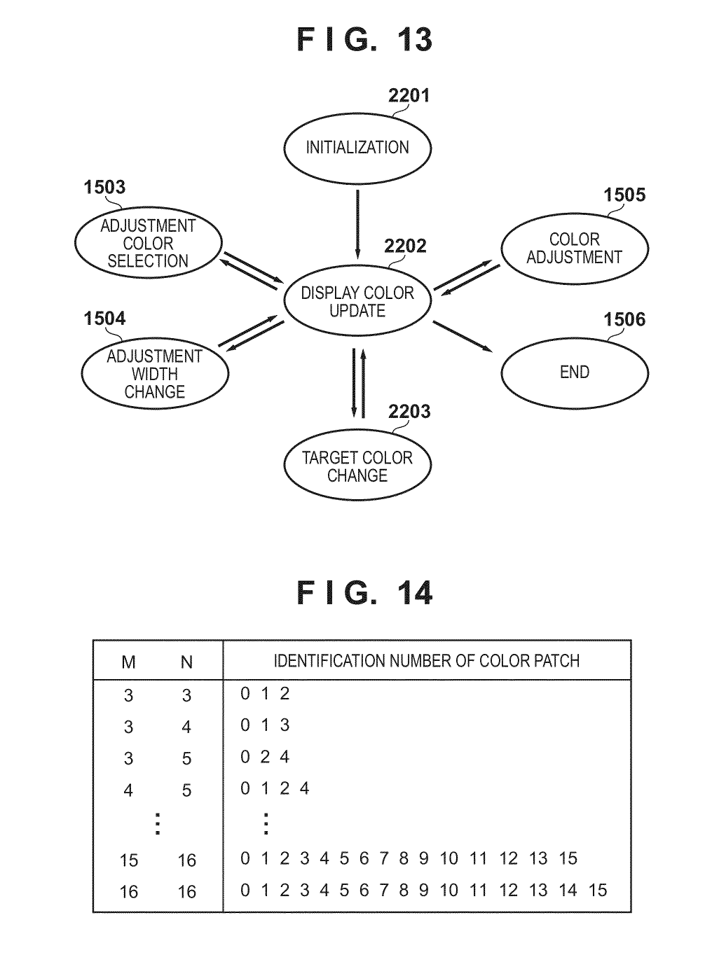

Inputs to the UI example shown in FIG. 12 and color matching adjustment processing according to the inputs in the third embodiment will be described below with reference to the state transition chart shown in FIG. 13. Note that the same reference numerals in FIG. 13 denote the same states as in FIG. 7 described above, and a description thereof will not be repeated.

In FIG. 13, in an initialization state 2201, color reproducibility information of the display and color information of color patches 607 to 612 of a print color section are loaded, and a table used to define adjustment colors from the number M of tones and the number N of display colors. Then, the state 2201 transits to a state 2202.

FIG. 14 shows an example of an adjustment color definition table, which is prepared in advance. As shown in FIG. 14, the adjustment color definition table describes identification numbers of color patches to be selected as adjustment colors in correspondence with the number M of tones and the number N of display colors. That is, a color patch selectable by spin buttons 613 is limited to those of identification numbers described in the table shown in FIG. 14 in accordance with the setting of the number M of tones.

In the display color update state 2202, color information L_{di}*a b_{di}* stored in a RAM 313 is converted into information R_{di}G_{di}B_{di} using tetrahedral interpolations using a table shown in FIG. 8 by processing to be described later, thereby updating RGB values of color patches 601 to 606 of a color display section. After that, a user input waiting state is set.

In the input waiting state of the state 2202, when the user operates the spin buttons 2101 used to select the number M of tones as adjustment targets, the state 2202 transits to a target color change state 2203. In the state 2203, colors to be displayed as the color patches 601 to 606 of the color display section as selection targets are decided and are stored in the RAM 313. After that, the state 2203 transits to the state 2202. Note that details of the display color decision processing in the state 2203 will be described later.

Display Color Decision Processing

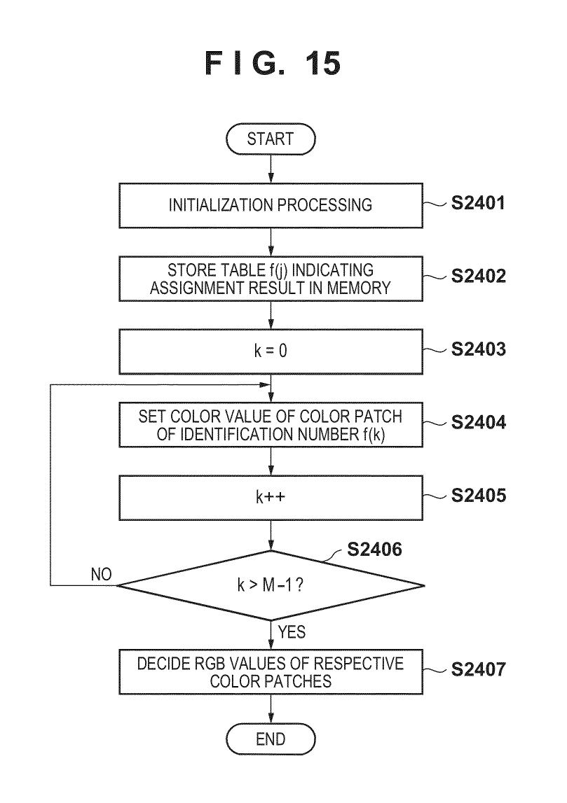

FIG. 15 is a flowchart showing the display color decision processing executed in the state 2203. Initialization processing (S2401) is executed first. That is, the number M of tones, the number N of display colors, and the adjustment color definition table are acquired to associate identification numbers j (=0 to M−1) of tones with identification numbers i of color patches. For example, when the number M of tones=3 and the number N of display colors=5, identification numbers i=0, 2, and 4 of color patches are obtained from the adjustment color definition table. Therefore, a table f(j) in which i=0, 2, and 4 are respectively assigned to j=0, 1, and 2 is stored in the RAM 313 (S2402), and a counter k is set to be 0 (initial value) (S2403).

Next, values L_{di}*a_{di}*b_{di}*(color values) corresponding to a color patch of an identification number f(k) are set (S2404). The values L_{di}*a_{di}*b_{di}* represent a display color of the color patch of the identification number f(k).

Next, the counter k is incremented (S2405), and it is determined whether or not setting of display colors of color patches of all adjustment target colors are complete (S2406). If the count value of the counter k satisfies the following equation (10), the process advances to step S2407; otherwise, the process returns to step S2404 to set a display color of the next color patch.

k>M−1 (10)

Next, RGB values of M color patches displayed on the display 318 are decided by executing tetrahedral interpolations using a table shown in FIG. 8 for the values L_{di}*a_{di}*b_{di}* of the respective color patches set in step S2404 (S2407), thus ending the processing.

Note that only the color patches (selected color patches) for the number M of tones need only be displayed on the display color selection. However, other color patches (non-selected color patches) may also be displayed. Color values L_{di}a_{di}b_{di} of each non-selected color path are calculated using:

$$\begin{matrix}{L}_{di}^{*} = \frac{{L}_{pi}^{*} - {L}_{pj + 1}^{*}}{{L}_{pj}^{*} - {L}_{pj + 1}^{*}} \times ( {L}_{dj}^{*} - {L}_{dj + 1}^{*} ) + {L}_{dj + 1}^{*} & ( 11 ) \\ {a}_{di}^{*} = \frac{{a}_{pi}^{*} - {a}_{pj + 1}^{*}}{{a}_{pj}^{*} - {a}_{pj + 1}^{*}} \times ( {a}_{dj}^{*} - {a}_{dj + 1}^{*} ) + {a}_{dj + 1}^{*} & ( 12 ) \\ {b}_{di}^{*} = \frac{{b}_{pi}^{*} - {b}_{pj + 1}^{*}}{{b}_{pj}^{*} - {b}_{pj + 1}^{*}} \times ( {b}_{dj}^{*} - {b}_{dj + 1}^{*} ) + {b}_{dj + 1}^{*} & ( 13 )\end{matrix}$$

where L_{dj}a_{dj}b_{dj} indicate a color of a selected color patch located at the left side of a non-selected color patch,

L_{dj+1}a_{dj+1}b_{dj+1} indicate a color of a selected color patch located at the right side of a non-selected color patch,

Lₚᵢaₚᵢbₚᵢ indicate a print color corresponding to a non-selected color patch,

Lₚⱼaₚⱼbₚⱼ indicate a print color corresponding to a selected color patch located on the left side of a non-selected color patch, and

Lₚⱼ₊ₗaₚⱼ₊ᵢbₚⱼ₊₁ indicate a print color corresponding to a selected color patch located on the right side of a non-selected color patch.

Note that the interpolation calculations on the L*a*b* space have been exemplified. Alternatively, interpolation calculations on an XYZ or RGB color space may be executed. For example, L*, a*, and b* in equations (11) to (13) may be respectively replaced by X, Y, and Z or R, G, and B. The calculation results of equations (11) to (13) are used when experimental results of tones which do not under go color matching experiments are interpolated from those of the selected color patches independently of whether or not to display the non-selected color patches.

As described above, according to the third embodiment, using gray tones which are designed to smoothly change, discrete points of gray tones are adjusted, and color matching points are estimated by interpolations. Thus, personal visual characteristics which maintain a gray balance can be easily acquired without increasing an operation load even when the number of gray tones as matching targets is increased.

### Fourth Embodiment

The fourth embodiment according to the present invention will be described below. The aforementioned first to third embodiments have explained the color adjustment method by only comparison between color patches 601 to 606 of a color display section of a display and color patches 607 to 612 of a print color section. In such color adjustment by visual comparison of display and print colors, it is often difficult to judge the next direction to adjust a color at the beginning of adjustment and a middle stage, and satisfactory color matching points cannot often be reached.

On the other hand, it is experimentally revealed that adjustment is facilitated and adjustment precision is improved by considering an adjustment initial setting point and information such as current adjustment results and those of other tones.

Hence, the fourth embodiment will explain a method of displaying a current adjustment state together with visual comparison of display and print colors in the above embodiments. Note that the arrangement of a color processing apparatus according to the fourth embodiment is the same as that of the first embodiment, and a description thereof will not be repeated. Color correction parameter calculation processing of the fourth embodiment will be briefly described below while focusing on differences from the first to third embodiments.

User Interface

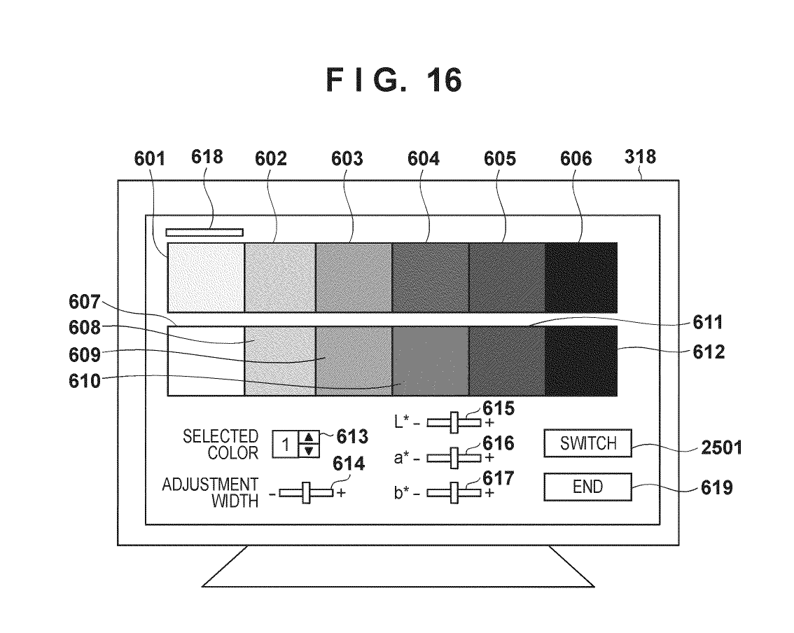

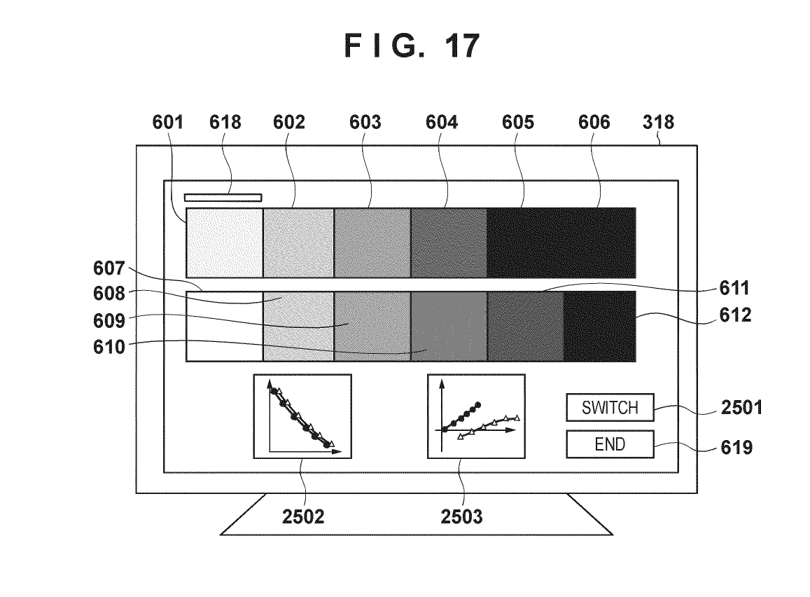

FIGS. 16 and 17 are views for explaining user interfaces displayed by a UI display unit 402 according to the fourth embodiment. In FIGS. 16 and 17, the same reference numerals denote the same components as those in FIG. 4 of the aforementioned first embodiment, and a description thereof will not be repeated.

In FIG. 16, a switch button 2501 is used to instruct to switch a UI. When the user presses the switch button 2501, a second UI shown in FIG. 17 is displayed. In FIG. 17, a window 2502 displays an L* adjustment state, the ordinate plots L*, and the abscissa plots identification numbers of the color patches 601 to 606 of the color display section. Symbol in the window 2502 indicates initial L* values of the color patches 601 to 606 of the color display section, and symbol Δ indicates current adjusted L*′ values of the color patches 601 to 606.

Also, a window 2503 displays a*b* adjustment states, the ordinate plots b*, and the abscissa plots a*. Symbol in the window 2503 indicates initial a*b* values of the color patches 601 to 606 of the color display section, and symbol Δ indicates current adjusted a*′b*′ values of the color patches 601 to 606.

In the fourth embodiment, the user can adjust the colors of the respective color patches with reference to the L* and a*b* initial values displayed on the windows 2502 and 2503, so that adjusted L*′ value and adjusted a*′b*′ values of each color patch smoothly change with respect to those of a neighboring color patch.

Color Matching Adjustment Processing

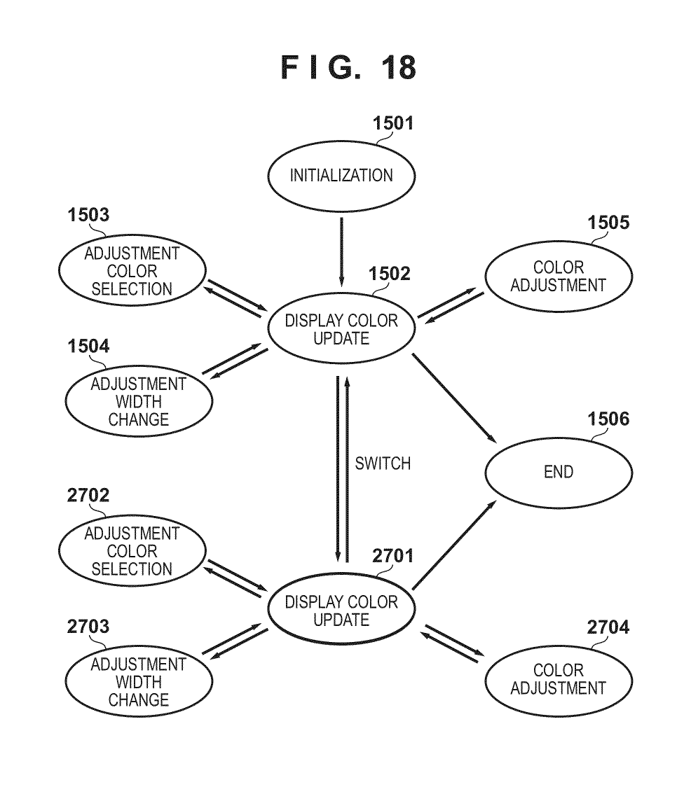

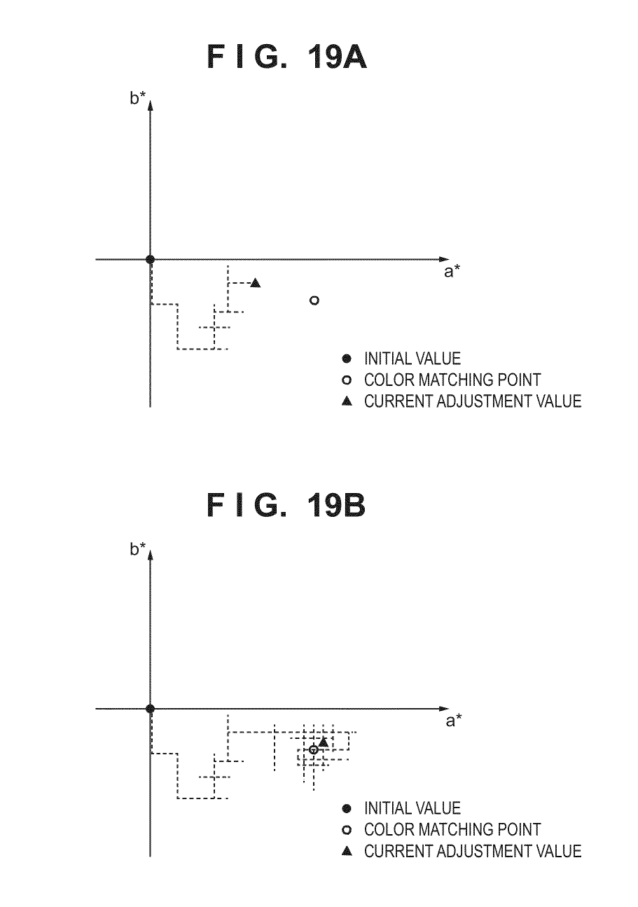

Inputs to the UI examples shown in FIGS. 16 and 17 and color matching adjustment processing according to the inputs according to the fourth embodiment will be described below with reference to the state transition chart shown in FIG. 18. Note that in FIG. 18, the same reference numerals denote the same states as those in FIG. 7 described above, and a description thereof will not be repeated.

Referring to FIG. 18, in an input waiting state of a display color update state 1502, when the user presses the switch button 2501, the state 1502 transits to a display color update state 2701 to display the second UI shown in FIG. 17. After that, a user input waiting state is set. When this second UI is displayed, plots of the windows 2502 and 2503 are displayed based on color information L_{di}*a_{di}*a_{di}*b_{di}* of initial values of the color patches of the color display section, and current adjusted color information L_{di}*′a_{di}*′b_{di}*′ of the color patches 601 to 606, which are obtained in the state 1501.

In the input waiting state of the state 2701, when the user changes an adjustment target color (selected color) using an operation unit 314, the state 2701 transits to an adjustment color selection state 2702. In the state 2702, after “i” which represents an identification number of the selected color and a display position of a selected color marker 618 are changed according to the change result of the selected color, the state 2702 transits to the state 2701.

In the input waiting state of the state 2701, when the user changes an adjustment width using the operation unit 314, the state 2701 transits to an adjustment width change state 2703. In the state 2703, a value of a variable α (<0) indicating a display adjustment variation width is stored in a RAM 313 according to the change result of the adjustment width, and the state 2703 transits to the state 2701.

In the input waiting state of the state 2701, when the user changes at least any of L_{di}*a_{di}*b_{di}* values using the operation unit 314, the state 2701 transits to a color adjustment state 2704. In the state 2704, the changed value L_{di}*a_{di}*b_{di}* are stored in the RAM 313, and the state 2704 transits to the state 2701.

In the input waiting state of the state 2701, when the user presses the switch button 2501, the state 2701 transits to the display color update state 1502 to display the first UI shown in FIG. 16. After that, the user input waiting state is set.

In the input waiting state of the state 2701, when the user presses an end button 619, the state 2701 transits to an end state 1506, thus acquiring personal color matching data. As described above, in the state 1506, the values L_{di}*′a_{di}*′b_{di}*′ currently stored in the RAM 313 are output to a personal color matching data acquisition unit 403 together with corresponding display RGB values and printer RGB values as personal color matching data of the user.

Note that in the above description, various kinds of adjustment are made from the operation unit 314 on the second UI. However, color adjustment can be done when the user directly drags the current adjusted L*′ value and adjusted a*′b*′ values indicated by symbol Δ on the windows 2502 and 2503.

As described above, since the user's color adjustment operations are assisted by graphically displaying information indicating initial setting values and current adjustment values in association with tones as adjustment targets, the adjustment precision can be expected to be improved.

### Fifth Embodiment

The fifth embodiment according to the present invention will be described below. The aforementioned first to fourth embodiments have explained the method of executing color adjustment by only comparison between color patches 601 to 606 of a display color section on a display and color patches 607 to 612 of a print color section. In such color adjustment by visual comparison of display and print colors, it is often difficult to judge whether or not an adjustment limit level is reached in an end stage of adjustment. It is experimentally revealed that when the user falls into such difficulty upon determination as to whether or not to end the adjustment, an adjustment point does not reach a point in the neighborhood of a color matching point yet, or it strays about the color matching point. Either state can be judged with reference to an adjustment history.

FIG. 19A shows an adjustment history example when an adjustment point does not reach a point in the neighborhood of a color matching point yet. In FIG. 19A, the ordinate plots b*, and the abscissa plots a*. Also, symbol indicates adjustment initial values, symbol ◯ indicates a color matching point, symbol ⋄ indicates a current adjustment point, and broken lines indicate an adjustment route so far. As can be seen from the adjustment route shown in FIG. 19A, when a point in the neighborhood of the color matching point cannot be reached, an adjustment route from the current adjustment point toward the color matching point cannot be found or the current adjustment point is located at the end of the adjustment route.

FIG. 19B shows an adjustment history example when an adjustment point strays around a color matching point. The respective axes, symbols, and broken lines in FIG. 19B are the same as those in FIG. 19A. As can be seen from the adjustment route shown in FIG. 19B, when an adjustment point strays around the color matching point, there are a large number of adjustment routes which cover around the neighborhood of the current adjustment point, and those adjustment routes have no ends. Note that to stray around the color matching point will be expressed as “fluctuations” hereinafter.

The fifth embodiment will explain a method of displaying an adjustment history so far in combination with visual comparison of display and print colors in the above embodiments in consideration of the aforementioned features of non-arrival or fluctuations with respect to the neighborhood of the color matching points. Note that the arrangement of a color processing apparatus according to the fifth embodiment is the same as that of the first embodiment, and a description thereof will not be repeated. Color correction parameter calculation processing of the fifth embodiment will be briefly described below while focusing on differences from the first to fourth embodiments.

User Interface

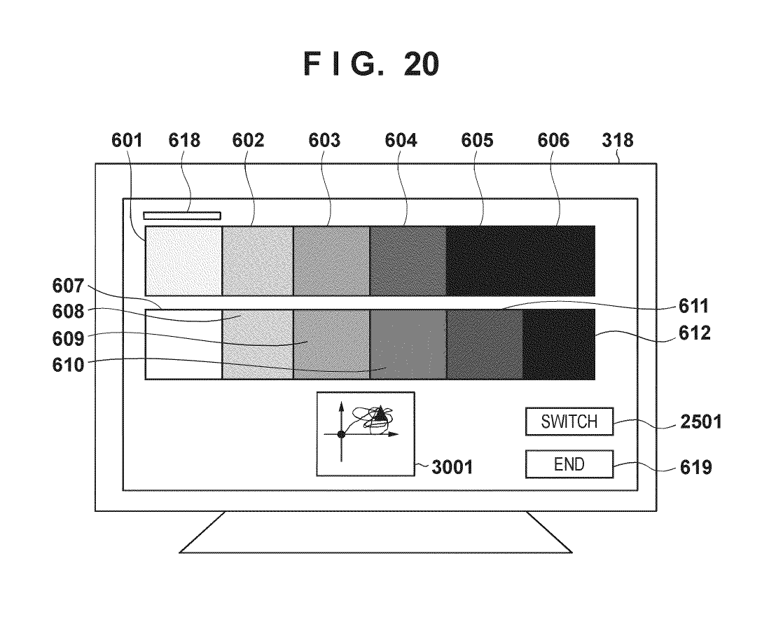

In the fifth embodiment, when the user presses a switch button 2501 of a first UI shown in FIG. 16, a third UI shown in FIG. 20 is displayed. In FIG. 20, a window 3001 displays an a*b* adjustment history, the ordinate plots b*, and the abscissa plots a*. A curve displayed on the window 3001 indicates a locus of color adjustment from the beginning of adjustment until the current adjustment point, symbol indicates adjustment initial values, and symbol ⋄ indicates a current adjustment point.

Color Matching Adjustment Processing

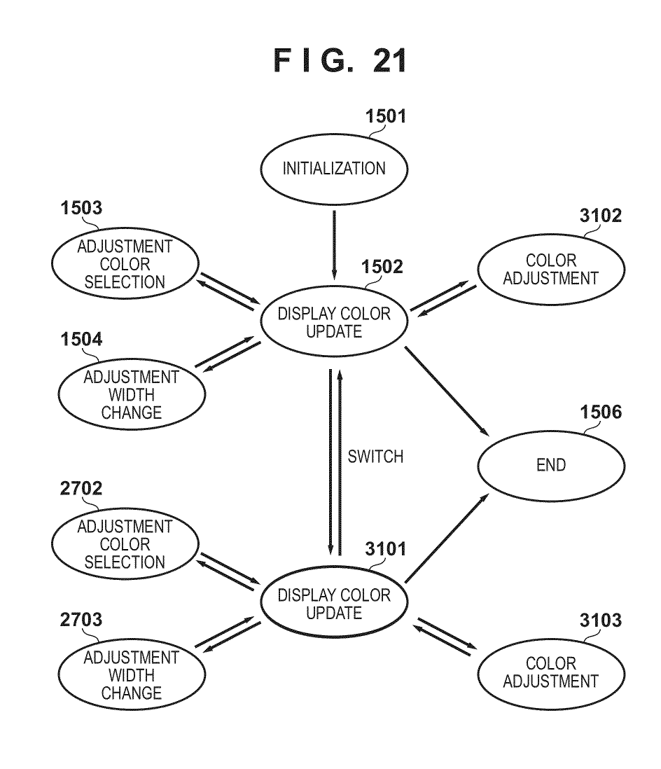

Inputs to the UI examples shown in FIGS. 16 and 20 and color matching adjustment processing according to these inputs in the fifth embodiment will be described below with reference to the state transition chart shown in FIG. 21. Note that in FIG. 21, the same reference numerals as in FIG. 18 above denote the same states, and a description thereof will not be repeated.

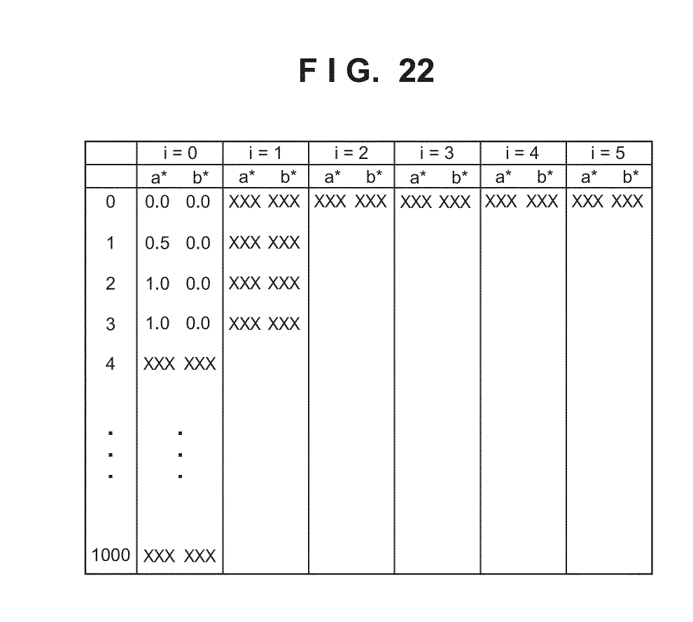

In FIG. 21, in an input waiting state of a state 1502, when the user performs color adjustment using any of sliders 615, 616, and 617, the state 1502 transits to a color adjustment state 3102. In the state 3102, L*a*b* values according to the change result of the sliders 615, 616, and 617, that is, L_{di}*a_{di}*b_{di}* values described by equations (1) to (6) are stored in a RAM 313. Then, a_{di}*b_{di}* values are separately stored in the RAM 313 as history information, and the state 3102 then transits to the state 1502. FIG. 22 shows an example of the data structure of the history information. As shown in FIG. 22, adjustment histories of a_{di}*b_{di}* values are held in correspondence with the color patches 601 to 606 (i=0 to 5) of the color display section.

In the input waiting state of the state 1502, when the user presses the switch button 2501, the state 1502 transits to a display color update state 3101 to display the third UI shown in FIG. 20, and a user input waiting state is then set. Note that when the third UI is displayed in the state 3101, a curve which connects adjustment history points corresponding to an identification number i of a selected color is displayed on the window 3001 based on the history information updated in the state 3102 (FIG. 22). The user can easily determine whether or not the current adjustment reaches an end stage with reference to this window 3001.

In the input waiting state of the state 3101, when the user changes an adjustment target color (selected color) using an operation unit 314, the state 3101 transits to an adjustment color selection state 2702. In the state 2702, i which represents an identification number of a selected color and a display position of a selected color marker 618 are changed according to the change result of the selected color, and the state 2702 then transits to the state 3101.

In the input waiting state of the state 3101, when the user changes an adjustment width using the operation unit 314, the state 3101 transits to an adjustment width change state 2703. In the state 2703, a value of a variable α (<0) indicating a display adjustment variation width is stored in the RAM 313 according to the change result of the adjustment width, and the state 2703 transits to the state 3101.

In the input waiting state of the state 3101, when the user changes at least any of L_{di}*a_{di}*b_{di}* values using the operation unit 314, the state 3101 transits to a color adjustment state 3103. In the state 3103, changed L_{di}*a_{di}*b_{di}* values and a_{di}*b_{di}* values as history information are stored in the RAM 313 as in the above color adjustment state 3102. After that, the state 3103 transits to the state 3101.

In the input waiting state of the state 3101, when the user presses the switch button 2501, the state 3101 transits to the state 1502 to display the first UI shown in FIG. 16, and a user input waiting state is then set.

In the input waiting state of the state 3101, when the user presses an end button 619, the state 3101 transits to an end state 1506 to acquire personal color matching data. As described above, in the state 1506, the values L_{di}*′a_{di}*′b_{di}*′ currently stored in the RAM 313 are output to a personal color matching data acquisition unit 403 together with corresponding display RGB values and printer RGB values as personal color matching data of the user.

Note that various kinds of adjustment are made from the operation unit 314 on the third UI. When the user judges to continue the color adjustment after he or she refers to the window 3001 in the state 3101, he or she may press the switch button 2501 to transit to the state 1502, and the first UI may be displayed. In this state, by transiting to the adjustment color selection state 1503 or color adjustment state 3102, the color adjustment is executed.

As described above, the user's adjustment operation is assisted by graphically displaying an adjustment history, thus allowing easy end determination of the adjustment.

### Sixth Embodiment

The sixth embodiment according to the present invention will be described below. The aforementioned first to fifth embodiments have explained the method of executing color adjustment of a display so that appearances of color patches 601 to 606 of a display color section on the display match those of corresponding color patches 607 to 612 of a print color section. In color adjustment by visual comparison of display and print colors, although appearances between color patches which indicate discretely extracted colors may be matched, color appearances may be locally mismatched (to be referred to as “color deviation” hereinafter) when colors of continuous tones like a gradation image are evaluated. In order to avoid such color deviation, respective color patches have to be individually re-adjusted to attain both color matching of the color patches and that of the gradation image. At this time, the following problem is posed. That is, it is not easily determine a color of which portion of a gradation image is adjusted when a certain color patch is adjusted.

Hence, the sixth embodiment will explain a method of clearly specifying a correspondence relationship between a color patch to be adjusted and a color of a gradation image. Note that the arrangement of a color processing apparatus according to the sixth embodiment is the same as that of the first embodiment, and a description thereof will not be repeated. Color correction parameter calculation processing of the sixth embodiment will be briefly described below while focusing on differences from the above embodiments.

User Interface

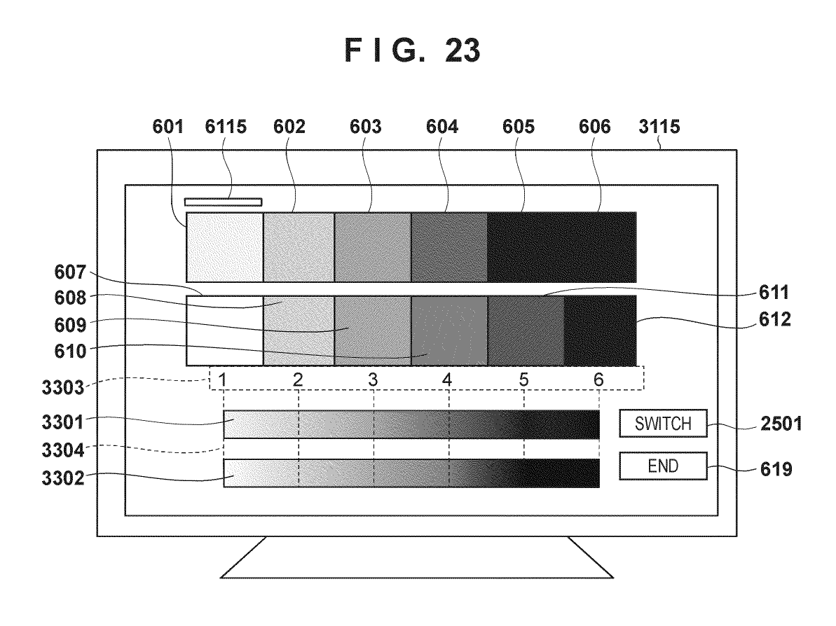

In the sixth embodiment, when the user presses a switch button 2501 of a first UI shown in FIG. 16, a fourth UI shown in FIG. 23 is displayed. In FIG. 23, an image display section 3301 displays a gradation image of display colors (to be referred to as “display gradation” hereinafter). A print section 3302 is displayed by laying out a printed matter on which a gradation image corresponding to the display gradation 3301 is printed on a screen of a display 318 (to be referred to as “print gradation” hereinafter). In the respective gradations 3301 and 3302, a left end corresponds to a maximum luminance signal value, and a right end corresponds to a minimum luminance signal value. An indication 3303 includes text indications of ID numbers of respective color patches 601 to 606 of the display color section. The text indications 3303 of the color patches are associated with positions of the same signal values as the color patches in the gradations 3301 and 3302 via guides 3304.

Color Matching Adjustment Processing

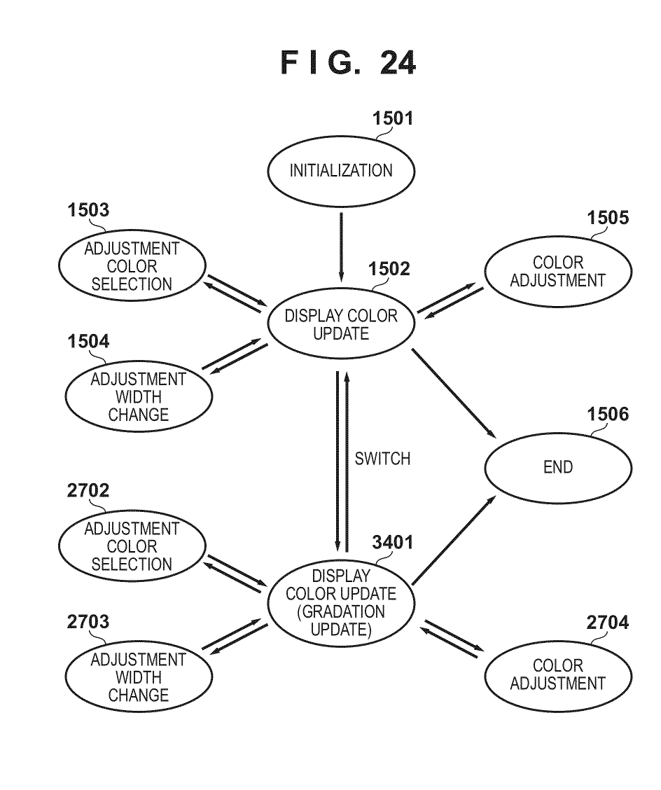

Inputs to the UI examples shown in FIGS. 16 and 23 and color matching adjustment processing according to these inputs in the sixth embodiment will be described below with reference to the state transition chart shown in FIG. 24. Note that in FIG. 24, the same reference numerals denote the same states as in FIG. 18 above, and a description thereof will not be repeated.

In FIG. 24, in an input waiting state of a state 1502, when the user presses the switch button 2501, the state 1502 transits to a display color update state 3401 to display the fourth UI shown in FIG. 23, and a user input waiting state is then set. When the fourth UI is displayed, a user's adjustment result is reflected to the display gradation 3301 by tetrahedral interpolations using a table shown in FIG. 8 based on L_{di}*a_{di}*b_{di}* values of respective color patches updated as the color adjustment result in a state 1505 or 2704. The user visually compares the display gradation 3301 and print gradation 3302, and can easily determine whether or not the current adjustment is also appropriate in the gradation image.

In the input waiting state of the state 3401, when the user changes an adjustment target color (selected color) using an operation unit 314, the state 3401 transits to an adjustment color selection state 2702. In the state 2702, i which represents an identification number of a selected color and a display position of a selected color marker 618 are changed according to the selected color, and the state 2702 then transits to the state 3401.

In the input waiting state of the state 3401, when the user changes an adjustment width using the operation unit 314, the state 3401 transits to an adjustment width change state 2703. In the state 2703, a value of a variable α (<0) indicating a display adjustment variation width is stored in a RAM 313 according to the change result of the adjustment width, and the state 2703 transits to the state 3401.

In the input waiting state of the state 3401, when the user changes at least any of L_{di}*a_{di}*b_{di}* values using the operation unit 314, the state 3401 transits to a color adjustment state 2704. In the state 2704, the changed value L_{di}*a_{di}*b_{di}* are stored in the RAM 313, and the state 2704 transits to the state 3401.

In the input waiting state of the state 3401, when the user presses the switch button 2501, the state 3401 transits to the state 1502 to display the first UI shown in FIG. 16, and a user input waiting state is then set.

In the input waiting state of the state 3401, when the user presses an end button 619, the state 3401 transits to an end state 1506 to acquire personal color matching data. As described above, in the state 1506, the values L_{di}*′a_{di}*′b_{di}*′ currently stored in the RAM 313 are output to a personal color matching data acquisition unit 403 together with corresponding display RGB values and printer RGB values as personal color matching data of the user.

Note that various kinds of adjustment are made from the operation unit 314 on the fourth UI. When the user judges to continue color adjustment after he or she refers to the display gradation 3301 in the state 3401, he or she may press the switch button 2501 to transit to the state 1502, and the first UI may be displayed. In this state, by transiting to the adjustment color selection state 1503 or color adjustment state 3102, the color adjustment is executed.

Note that the print gradation 3302 is laid out with respect to the display gradation 3301 on the fourth UI. Even when only the display gradation 3301 is displayed, the presence/absence of occurrence of color deviation and the like can be confirmed.

As described above, user's adjustment is assisted by clearly specifying a corresponding position on a gradation image in association with a color patch which is to undergo color adjustment.

### Modification of Embodiments

The above embodiments have exemplified the case in which color matching experiments are conducted using an RGB printer as an input device and a monitor as an output device taking soft-proofing as an example. However, input and output devices are not limited to these devices. For example, the present invention is applicable to other image input and output devices such as a CMYK printer and projector.

The above embodiments have exemplified the case in which values on the CIELAB space are used as colorimetric values. However, the present invention is not limited to this example, and other color spaces such as CIELUV, CIECAM97, and CIECAM02 spaces can be used.

The above embodiments have exemplified the case in which the present invention is implemented as an application used to attain color matching between input and output devices. Alternatively, the present invention may be embedded in a device as, for example, a calibration function. For example, the present invention can be applied as a calibration function of a monitor as an output device.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-112685 filed May 16, 2012 which is hereby incorporated by reference herein in its entirety.

What is claimed is:

1. A color processing apparatus comprising:
a provider configured to provide a user interface used to input a plurality of adjustment values required to color-match display colors of a plurality of tones on a display device with corresponding target colors of a plurality of tones;
an acquisition unit configured to acquire color matching data indicating correspondence between adjusted display colors of the plurality of tones and the target colors of the plurality of tones from the plurality of adjustment values; and
a generator configured to generate correction parameters of colors displayed on the display device from the color matching data.

2. The apparatus according to claim 1, wherein the target colors are colors obtained by printing color data of the display colors on a recording medium.

3. The apparatus according to claim 1, wherein the display colors of the plurality of tones are colors of a plurality of tones which close to a gray line.

4. The apparatus according to claim 1, wherein the display colors of the plurality of tones are colors of at least three tones which close to a gray line.

5. The apparatus according to claim 1, wherein the target colors of the plurality of tones are provided as a printed matter, and the display colors of the plurality of tones have substantially the same shapes and the same layout as shapes on the printed matter and a layout of the target colors on the printed matter.

6. The apparatus according to claim 1, wherein the user interface comprises:
a display section configured to display the display colors of the plurality of tones on a screen of the display device in correspondence with an order of arrangement of the target colors of the plurality of tones;
a selection section configured to select a display color of an adjustment target from display colors of the plurality of tones based on a user instruction; and
an input section configured to input an adjustment value of the selected display color based on a user instruction.

7. The apparatus according to claim 6, further comprising a display color controller configured to control colors of the display colors displayed by the display section.

8. The apparatus according to claim 7, wherein the display color controller updates a color of the selected display color in accordance with the input adjustment value.

9. The apparatus according to claim 7, wherein the display color controller reflects the adjustment value input to a display color of a tone, which is adjacent to the selected display color, to the selected display color.

10. The apparatus according to claim 6, wherein the user interface further comprises a setting section configured to set a number of tones of first display colors for which the adjustment value is to be input of the display colors of the plurality of tones.

11. The apparatus according to claim 10, wherein the number of tones configured to be set is not less than 3 and is not more than a number of the display colors.

12. The apparatus according to claim 10, wherein display colors to be set as the first display colors are selected from the display colors of the plurality of tones based on the number of tones and the number of display colors.

13. The apparatus according to claim 10, further comprising a calculator configured to calculate adjustment values corresponding to second display colors other than the first display colors of the display colors of the plurality of tones based on adjustment values input for the first display colors.

14. The apparatus according to claim 6, wherein the user interface further comprises a display window configured to comparably display initial chromaticity values and chromaticity values after the adjustment values are input respectively for the display colors of the plurality of tones.

15. The apparatus according to claim 6, wherein the user interface further comprises a display window configured to display an input history of the adjustment values for the selected display color.

16. The apparatus according to claim 6, wherein the display section further displays a gradation image corresponding to the display colors of the plurality of tones, and corresponding positions between the plurality of tones and the gradation image.

17. The apparatus according to claim 16, further comprising a display color controller configured to update the gradation image according to the input adjustment value.

18. A color processing method comprising:
using a processor to performs the steps of:
providing a user interface used to input a plurality of adjustment values required to color-match display colors of a plurality of tones on a display device with corresponding target colors of a plurality of tones;
acquiring color matching data indicating correspondence between adjusted display colors of the plurality of tones and the target colors of the plurality of tones from the plurality of adjustment values; and
generating correction parameters of colors displayed on the display device from the color matching data.

19. A non-transitory computer readable medium storing program for causing a computer to perform the color processing method according to claim 18.
